(19) United States
(12) Patent Application Publication
(10) Pub. No.: US 2024/0300085 A1
(43) Pub. Date: Sep. 12, 2024

(54) STRIKING IMPLEMENT WITH ANTI-SHOCK GRIP

(71) Applicant: Apex Brands, Inc., Apex, NC (US)

(72) Inventors: Mark Anthony Ezzo, Troutman, NC (US); Matthew John Poppe, Raleigh, NC (US); Andrew Thomas Speciale, Raleigh, NC (US)

(21) Appl. No.: 18/272,137

(22) PCT Filed: Jan. 26, 2022
(86) PCT No.: PCT/US2022/013823

§ 371 Date: Jul. 13, 2023

Related U.S. Application Data
(60) Provisional application No. 63/142,093, filed on Jan. 27, 2021.

(51) Int. Cl. B25G 1/01; B25G 3/34

(52) U.S. Cl. CPC B25G 1/01; B25G 3/34

(57) ABSTRACT

A hand tool may include a head having a bell and a face for delivering an impact, and a handle operably coupled to the head and extending linearly away from the head along an axis. The handle may include a grip portion proximate to a distal end of the handle. The grip portion may include a core material, an anti-vibration layer disposed around a periphery of the core material in a radial direction substantially perpendicular to the axis, and an outer layer disposed around a periphery of the anti-vibration layer. The anti-vibration layer is made of a first elastomeric polymeric material and the outer layer may be made of a second elastomeric polymeric material. The first elastomeric polymeric material may be softer than the second elastomeric polymeric material. A maximum acceleration ratio between the head and the handle is 0.075.

### TECHNICAL FIELD

Example embodiments generally relate to hand tools and, in particular, relate to a hammer or other striking implement that is structured to have reduced vibration or energy translation during operation.

### BACKGROUND

Hand tools are commonly used across all aspects of industry and in the homes of consumers. Hand tools are employed for multiple applications including, for example, tightening, component joining, and/or the like. For some joining applications, a striking implement such as a hammer, and particularly a hammer and nails, may be used. However, hammers are used in many other contexts as well, and are a tool that has been in use by humans for many thousands of years.

The history of hammers, like so many other tools, is a tale of continuous improvement as better materials and ways of employing those materials have advanced. From stone hammer heads with bone or wooden handles, to the replacement of the stone with stronger and stronger metals, hammers evolved significantly. Later, to improve durability, the entire hammer (i.e., the head and the handle, began to be made from metallic materials. However, in spite of the great improvement in durability, the weight of such devices and the cost in terms of relatively expensive metallic materials demanded yet further improvement.

Modern striking implements are often made with combinations of materials that are meant to balance the cost and durability. However, even these modern striking implements can suffer from excessive production of vibration during use. This vibration can be very stressful to the hand muscles. Moreover, prolonged vibration can cause numbness and discomfort to the user's hand. Accordingly, it may be desirable to improve hammer designs relative to the amount of vibration that such designs produce.

### BRIEF SUMMARY OF SOME EXAMPLES

In an example embodiment, a hand tool may be provided. The hand tool may include a head having a bell and a face for delivering an impact, and a handle operably coupled to the head and extending linearly away from the head along an axis. The handle may include a grip portion proximate to a distal end of the handle. The grip portion may include a core material, an anti-vibration layer disposed around a periphery of the core material in a radial direction substantially perpendicular to the axis, and an outer layer disposed around a periphery of the anti-vibration layer. The anti-vibration layer may be made of a first elastomeric polymeric material having a Shore A hardness between about 42 and about 48. The outer layer may be made of a second elastomeric polymeric material having a Shore A hardness between about 50 and about 65. A thickness of the anti-vibration layer may be thicker than a thickness of the outer layer.

In another example embodiment, a hand tool may be provided. The hand tool may include a head having a bell and a face for delivering an impact, and a handle operably coupled to the head and extending linearly away from the head along an axis. The handle may include a grip portion proximate to a distal end of the handle. The grip portion may include a core material, an anti-vibration layer disposed around a periphery of the core material in a radial direction substantially perpendicular to the axis, and an outer layer disposed around a periphery of the anti-vibration layer. The anti-vibration layer may be made of a first elastomeric polymeric material having a Shore A hardness between about 10 and about 45. The outer layer may be made of a second elastomeric polymeric material having a Shore A hardness between about 48 and about 53. A thickness of the anti-vibration layer may be thinner than a thickness of the outer layer.

In another example embodiment, a hand tool may be provided. The hand tool may include a head having a bell and a face for delivering an impact, and a handle operably coupled to the head and extending linearly away from the head along an axis. The handle may include a grip portion proximate to a distal end of the handle. The grip portion may include a core material, an anti-vibration layer disposed around a periphery of the core material in a radial direction substantially perpendicular to the axis, and an outer layer disposed around a periphery of the anti-vibration layer. The anti-vibration layer may be made of a first elastomeric polymeric material and the outer layer may be made of a second elastomeric polymeric material. The first elastomeric polymeric material may be softer than the second elastomeric polymeric material. A maximum acceleration ratio between the head and the handle is 0.075.

In another example embodiment, a method of manufacturing a hand tool is provided. The method may include operably coupling an intermediate layer to a metallic or fiber reinforced polymeric material core. The method may further include selecting a thickness relationship for an anti-vibration layer and an outer layer that is harder than the anti-vibration layer, where the selected thickness relationship determines a respective range of hardness values for the anti-vibration layer and the outer layer. The method may further include operably coupling the anti-vibration layer having a thickness and hardness determined by the selected thickness relationship and range of hardness values to the intermediate layer. The method may also include operably coupling an outer layer having a thickness and hardness determined by the selected thickness relationship and range of hardness values to encapsulate the anti-vibration layer.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1A illustrates a plan view of a hammer with a vibration isolated handle portion in cross section according to an example embodiment;

FIG. 1B illustrates a plan view of an alternative design that differs from the example of FIG. 1A on the basis of the relative thicknesses of various layers of the vibration isolation structures in accordance with an example embodiment;

FIG. 2A illustrates a perspective view of a hammer that employs a core that is made of forged steel according to an example embodiment;

FIG. 2B illustrates an exploded view of the various layers used for vibration isolation according to an example embodiment;

FIG. 2C shows a cross section view bisecting the grip portion of the hammer according to an example embodiment;

FIG. 2D is a cross section view taken along line A-A′ from FIG. 2A according to an example embodiment;

FIG. 3A illustrates a perspective view of a hammer that employs a core that is made of fiber reinforced polymeric material according to an example embodiment;

FIG. 3B illustrates an exploded view of the various layers used for vibration isolation according to an example embodiment;

FIG. 3C shows a cross section view bisecting the grip portion of the hammer according to an example embodiment;

FIG. 3D is a cross section view taken along line A-A′ from FIG. 2A according to an example embodiment;

FIG. 4 is a block diagram of a method of making a hand tool in accordance with an example embodiment;

FIG. 5 illustrates a side view of the hammer with a test rig for measuring acceleration versus time in accordance with an example embodiment; and

FIG. 6 illustrates plots of acceleration versus time for a head and handle of the hammer of a hand tool in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of a hand tool (e.g., a hammer or other striking implement) with an improved design that provides for the introduction of vibration reducing structures in the form of layers of material having different hardness levels into the handle. In this regard, for example, the vibration reducing structures may be provided into the grip portion of the handle, which is distally located relative to a beam portion (or simply, the “beam”) of the handle. The beam portion extends from the eye portion of the head to the grip portion. In any case, the vibration reducing structures may be provided to have controlled relationships between the hardness levels of the layers, and the relative thicknesses of the layers. The resulting hammer can be produced relatively simply, and easily, but is also less susceptible to vibration, while still remaining durable and cosmetically attractive.

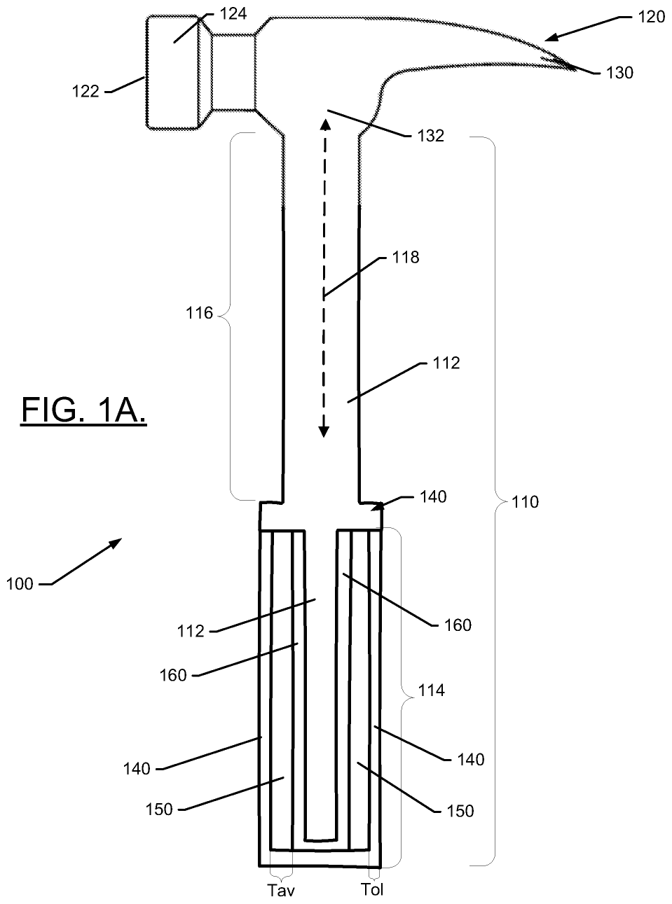

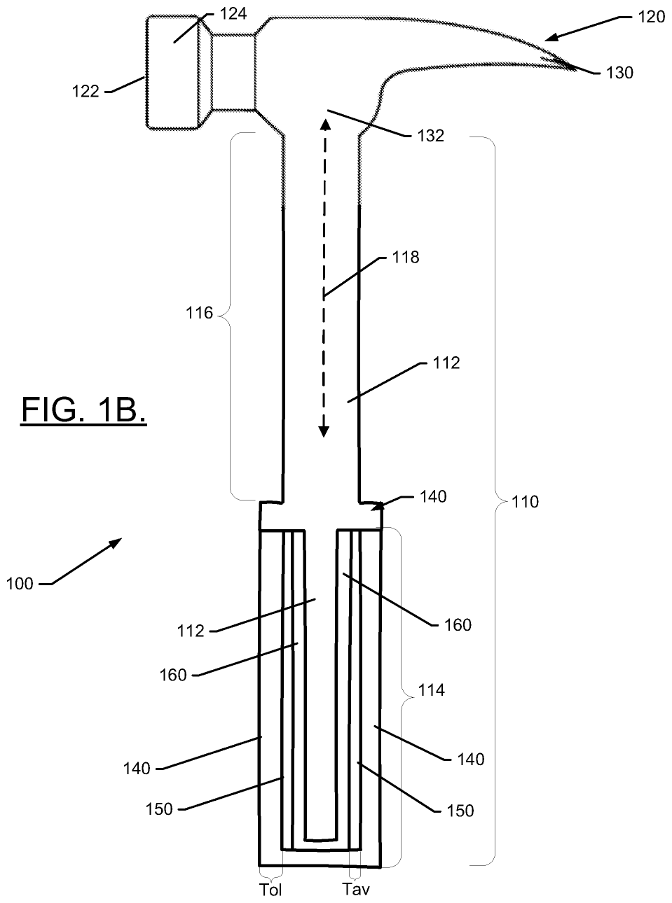

FIGS. 1A and 1B illustrate various views and structures associated with production of a hammer 100 according to an example embodiment. In this regard, FIG. 1A illustrates a plan view of the hammer 100, where a handle portion 110 of the hammer 100 is shown in cross section. The cross section cut bisects the handle portion 110 to divide the handle portion 110 into symmetrical right and left halves. Only the right half is shown in FIG. 1A. Meanwhile,

FIG. 1B shows the same view of the hammer 100, but a slightly different structural layering strategy is employed in the example of FIG. 1B in that different relative thicknesses and hardness levels are chosen for the materials in layers employed in parts of the handle portion 110 of the hammer 100 as described in greater detail below.

The hammer 100 of FIGS. 1A and 1B generally includes a head 120 and the handle portion 110. The head 120 may include a number of parts such as, for example, a face 122, which forms the striking surface of the hammer 100, and which is disposed at a distal end of a bell 124 of the head 120. Opposite the face 122, the head 120 may further include a claw 130. The bell 124 may be separated from the claw 130 by an eye portion 132. The lateral side of the head 120 (i.e., between the claw 130 and the bell 124, and above the eye portion 132) may be referred to as a cheek. The eye portion 132 may correspond to the eye that typically received the handle when the handle was made of a separate component or material from the head 120. However, in some examples, the head 120 and a core 112 of the handle portion 110 may be cast or forged as a single unitary piece. Thus, the eye portion 132 simply correlates to the location of the eye on a conventional multi-piece hammer, but does not necessarily function as such. Instead, the eye portion 132 therefore represents a point at which the handle portion 110 intersects with the head 120. Meanwhile, in examples where the head 120 and the core 112 are separate components, the head 120 and core 112 are joined together at the eye portion 132.

The core 112 may be steel or another rigid material or alloy in some examples. However, in other cases, the core 112 may be made from a rigid fiberglass core material, or other rigid composite materials. As an example, the core 112 may be a pultruded or extruded fiber reinforced polymeric material. It is noteworthy that example embodiments may be practiced regardless of the specific material used to form the core 112. In this regard, the principles associated with providing vibration reduction structures in the handle portion 110 according to example embodiments universally apply to any core material used.

The claw 130 may include two laterally extending claw members having a nail slot formed therebetween. The head of a nail can be placed in the nail slot and the claw members may engage the head 120 such that when the hammer 100 is pivoted about the eye portion 132, leverage is placed on the nail to remove the nail from the medium into which it had been driven. The claw 130 may have other uses as well, often related to prying. It should also be appreciated that the claw 130 may be replaced by a peen in some cases, and thus the particular design of the head 120 may be different in some cases without impacting other aspects of example embodiments.

The handle portion 110 may include a grip portion 114 and a beam portion (or beam 116). The beam 116 may extend from the eye portion 132 (at a proximal end of the beam 116) to the grip portion 114 (at a distal end of the beam 116). Thus, a proximal end of the grip portion 114 may be attached to a distal end of the beam 116, and a distal end of the grip portion 114 may extend away from the eye portion 132 and the beam 116 in alignment with the beam 116. The grip portion 114 and the beam 116 may therefore have a longitudinal centerline (or axis 118) that is common and extends away from the eye portion 132.

In some cases, core 112 may be substantially rectangular in shape (e.g., a rectangular prism shape). In the example of FIGS. 1A and 1B, the core has a transition piece 140 formed at an intersection between the portion of the core 112 that is in the beam 116 and the portion of the core 112 that is in the grip portion 114. The thickness and width dimensions of parts of the core 112 that are in the grip portion 114 are smaller than the thickness and width dimensions of parts of the core 112 that are in the beam 116. However, these thickness and width dimensions could alternatively be the same or switched in relative size in alternative embodiments. Other small changes could also be provided in that, for example, corners or edges of the rectangular pieces may be smoothed or rounded to form a rectangular cross section with rounded or smooth edges, or even an oval cross section in some cases.

In an example embodiment, vibration resistance may be provided in the handle portion 110 by using layers of material to form a grip, where the layers of material are selected to have different hardness levels and thickness relationships that have been found to reduce vibration effectively. In this regard, the hammer 100 of FIGS. 1A and 1B generally includes a structure having a very hard material at its center (i.e., the core 112). In this regard, as noted above, the core 112 may be metal or a fiberglass core material that has a very high hardness level. Meanwhile, an outer layer 140 of outer grip material may be selected to have a relatively high hardness level (but generally lower than the hardness level of the core 112), and an anti-vibration (or vibration reducing) layer 150 may be disposed in between the core 112 and the outer layer 140. The anti-vibration layer 150 may be softer than the outer layer 140. As noted above, selection of specific relationships between the hardness level of the materials used in the outer layer 140 and the anti-vibration layer 150 and between the relative thicknesses of the outer layer 140 and the anti-vibration layer 150 may provide superior anti-vibration characteristics while also enabling the resulting structures to be easily and cheaply made.

In some example embodiments, the portion of the core 112 that is located in the grip portion 114 may be mechanically fastened or bonded (directly or indirectly) to one or more of the other layers of the grip portion 114. The mechanical fastening or bonding may ensure that the grip portion 114 (and any layers thereof) maintains structural integrity during use, and in any normal situations the hammer 100 may encounter. Although not required, some embodiments may employ an optional intermediate layer 160 (or substrate) that may be placed between the core 112 and the anti-vibration layer 150. The intermediate layer 160 may be made of a rigid material (e.g., polypropylene having a Shore D hardness of about 70 to 80) that is molded onto the core 112. The core 112 (in the grip portion 114) may include cavities, ridges or other structures into which portions of the intermediate layer 160 may penetrate during molding in order to mechanically fasten the core 112 directly to the intermediate layer 160. As will be discussed in greater detail below, the intermediate layer 160 may further include physical structures that mechanically engage with the outer layer 140 and/or the anti-vibration layer 150 in order to mechanically fasten the core 112 (indirectly via the intermediate layer 160) to the outer layer 140 and/or the anti-vibration layer 150.

The anti-vibration layer 150 may be molded on top of the core 112 and the intermediate layer 160. The anti-vibration layer 150 may be made of an elastomeric polymeric material (e.g., thermoplastic elastomer (TPE) or thermoplastic urethane (TPU)). The anti-vibration layer 150 may be softer than both the intermediate layer 160 (if employed) and the outer layer 140. In this regard, the anti-vibration layer 150 may be made from a material selected to be in a range of hardness levels that is dependent upon relative thicknesses of the anti-vibration layer 150 and the outer layer 140. A first hardness level range may be defined between about a Shore A hardness of 42 to 48, and a second hardness level range may be defined between about a Shore A hardness of 10 to 45. The first hardness level range (i.e., Shore A hardness of 42 to 48) may be used when the anti-vibration layer 150 is thicker than the outer layer 140. Meanwhile, the second hardness level range (i.e., Shore A hardness of 10 to 45) may be used when the anti-vibration layer 150 is thinner than the outer layer 140.

The outer layer 140 may also be made of an elastomeric polymeric material (e.g., thermoplastic elastomer (TPE) or thermoplastic urethane (TPU). However, the outer layer 140 may be harder than the anti-vibration layer 150, and may also be provided in two hardness level ranges that are selected dependent upon the relationship of the thicknesses between the outer layer 140 and the anti-vibration layer 150. In this regard, for example, a third hardness level range may be defined between about a Shore A hardness of 50 to 65, and a fourth hardness level range may be defined between about a Shore A hardness of 48 to 53. The third hardness level range (i.e., Shore A hardness of 50 to 65) may be used when the anti-vibration layer 150 is thicker than the outer layer 140. Meanwhile, the fourth hardness level range (i.e., Shore A hardness of 48 to 53) may be used when the anti-vibration layer 150 is thinner than the outer layer 140.

FIG. 1A shows the anti-vibration layer 150 having a thickness (Tav) that is greater than a thickness (Tol) of the outer layer 140. Meanwhile, FIG. 1B shows the thickness (Tol) of the outer layer 140 being greater than the thickness (Tav) of the anti-vibration layer 150. In some example embodiments, a range of thicknesses of the anti-vibration layer 150 and the outer layer 140 may generally extend between about 2 mm to about 7 mm. In the example of FIG. 1A, the thickness (Tav) of the anti-vibration layer 150 is less than about 1 mm thicker than the thickness (Tol) of the outer layer 140. In the example of FIG. 1B, the thickness (Tol) of the outer layer 140 is less than about 2 mm thicker than the thickness (Tav) of the anti-vibration layer 150.

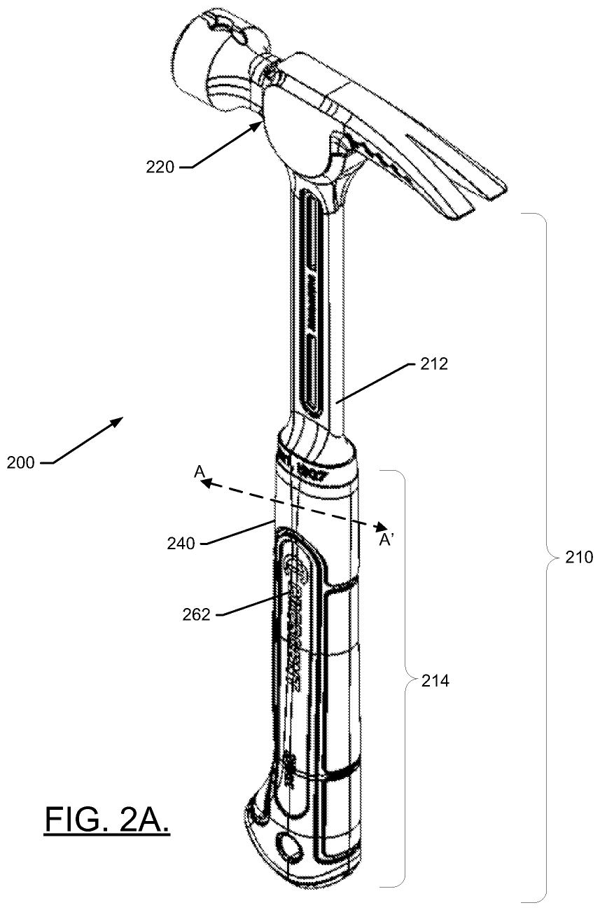

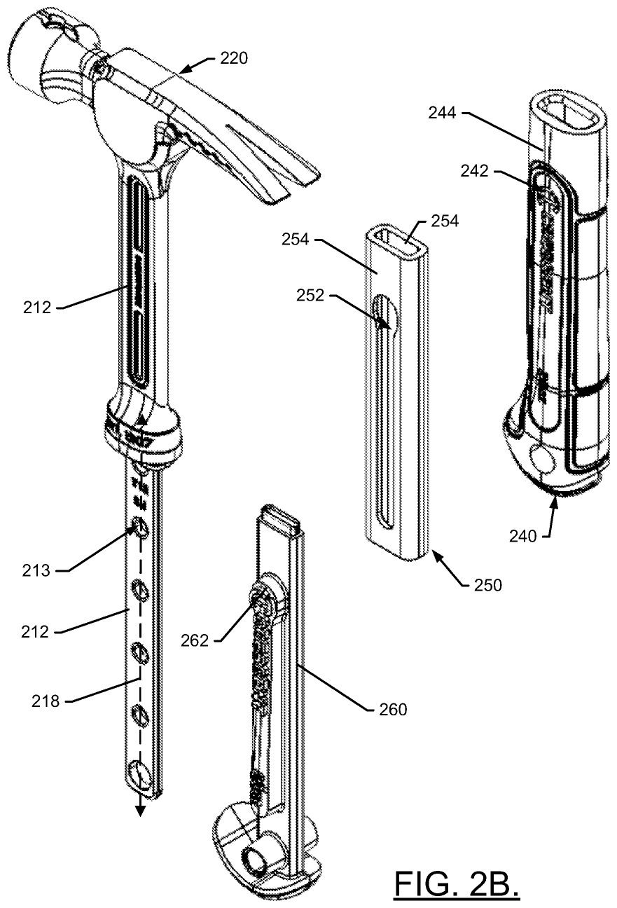

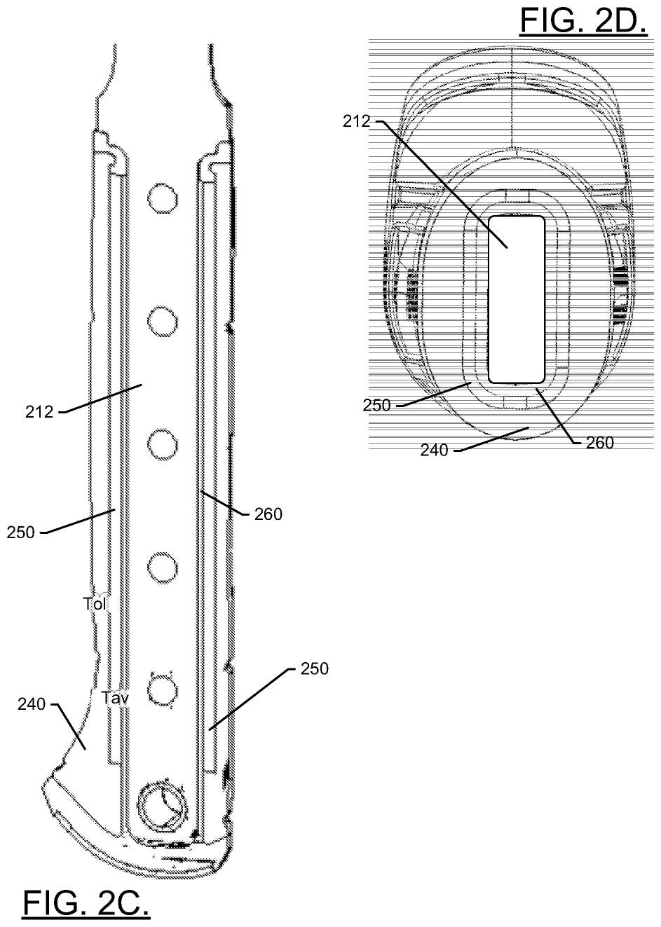

FIG. 2A shows perspective view of a hammer 200 that employs a core 212 that is made of forged steel (although titanium or other metallic materials could alternatively be used). Meanwhile, FIG. 2B illustrates an exploded view of the various layers used for vibration isolation as discussed above. FIG. 2C shows a cross section view bisecting the grip portion 214 of the hammer 200, and FIG. 2D is a cross section view taken along line A-A′ from FIG. 2A. As shown in FIG. 2A, a head 220 of the hammer 200 is operably coupled to a handle portion 210 that includes a core 212 extending into grip portion 214. The grip portion 214 employs a layered structure as described above in reference to FIG. 1A. In particular, the core 212 may include cavities 213 to enable material from intermediate layer 260 (an example of intermediate layer 160 above) to penetrate therein for mechanical fastening of the core 212 to the intermediate layer 260. The intermediate layer 260 may be molded onto the core 212 as a first step for constructing the hammer 200 (after forging and any treatment of the head 220 and core 212, of course). However, alternatives to molding may be used in some cases. For example, the intermediate layer 260 could be pre-formed (e.g., as a sleeve) and may be slid over the core 212, or the intermediate layer 260 may have a clamshell design.

Although not required, the intermediate layer 260 may include retention members 262 that extend outwardly from an axis 218 of the handle portion 210. The retention members 262 may be used to mechanically fasten the intermediate layer 260 to an outer layer 240 and/or an anti-vibration layer 250 of the grip portion 214. The retention members 262 in this example include branding materials thereon. However, there is no need for branding to be employed in the retention members 262 and some embodiments may simply employ geometrically shaped protrusions as the retention members 262.

The anti-vibration layer 250 may be molded onto the intermediate layer 260 after the intermediate layer 260 has been molded onto the core 212. However, in some cases, the intermediate layer 260 could be omitted, and the anti-vibration layer 250 may be molded directly onto the core 212. The anti-vibration layer 250 of this example has a substantially rectangular prism shape (albeit with rounded corners between sides), and further has a substantially consistent thickness (Tav). Although not required, the anti-vibration layer 250 also includes retention cavities 252. The retention cavities 252 are molded around the retention members 262, and therefore facilitate mechanical fastening of the anti-vibration layer 250 to the intermediate layer 260, thereby providing inter-layer bonding. Of note, the retention cavities 252 may be formed on lateral sides 254 (i.e., not front or rear sides) of the anti-vibration layer 250. The impact transmitted to the anti-vibration layer 250 when the head 220 strikes an object is typically transmitted in a direction that is parallel to the direction of extension of the lateral sides 254. Thus removing material from the lateral sides 254 of the anti-vibration layer 250 has less impact on damping performance of the anti-vibration layer 250. As noted above, alternatives to molding may be used for operably coupling the anti-vibration layer 250 to the intermediate layer 260 in some cases. For example, the anti-vibration layer 250 could be pre-formed (e.g., as a sleeve) and may be slid over the intermediate layer 260 (or core 212), or the anti-vibration layer 250 may have a clamshell design.

The outer layer 240 may then be molded onto the anti-vibration layer 250. However, alternatives to molding may be used for operably coupling the anti-vibration layer 250 to the outer layer 240 in some cases. For example, the outer layer 240 could be pre-formed (e.g., as a sleeve) and may be slid over the anti-vibration layer, or the outer layer 240 may have a clamshell design. The outer layer 240 of this example has a substantially rectangular prism shape (albeit with rounded corners between sides), and further has a thickness (Tol). Of note, a distal end of the outer layer 240 in this example is thicker to enhance gripping for the user. So it should be appreciated that some contouring or other features that enhance grip may be employed to alter the general shape.

Although not required, the outer layer 240 of this example also includes retention orifices 222. The retention orifices are molded around the retention members 262, and therefore facilitate mechanical fastening of the outer layer 240 to the intermediate layer 260, thereby providing inter-layer bonding. Of note, the retention orifices 242 may be formed on lateral sides 264 (i.e., not front or rear sides) of the outer layer 240. As noted above, removing material from the lateral sides 244 of the outer layer 240 may have less impact on damping performance of the outer layer 240.

As best seen in FIGS. 2C and 2D, the outer layer 240 has a greater thickness than the anti-vibration layer 250. Thus, for this example, it can be expected also that the outer layer 240 employs the fourth hardness level range (e.g., Shore A hardness of 48 to 53) and the anti-vibration layer 250 employs the second hardness level range (e.g., Shore A hardness of 10 to 45). However, example embodiments could switch the relative thicknesses by also switching the ranges of hardness levels used (e.g., employing the first and third hardness level ranges noted above).

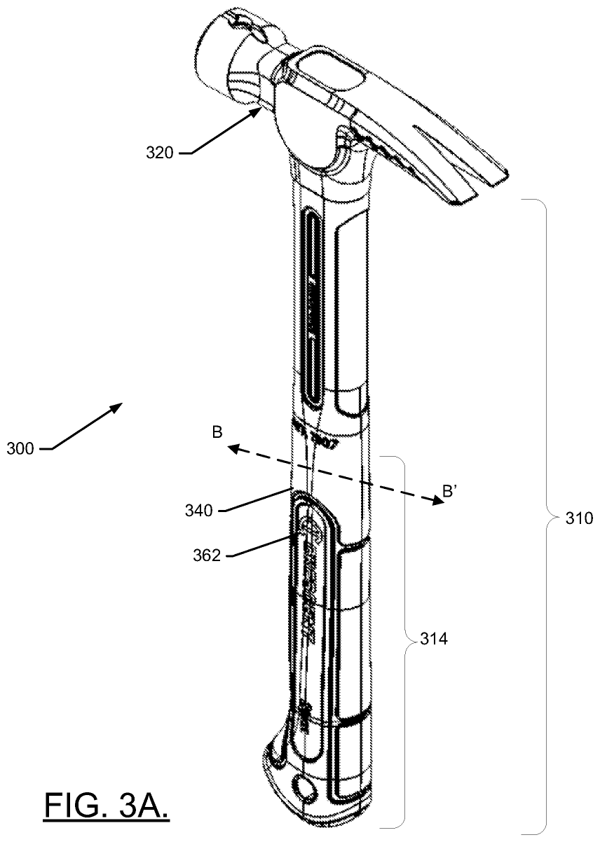

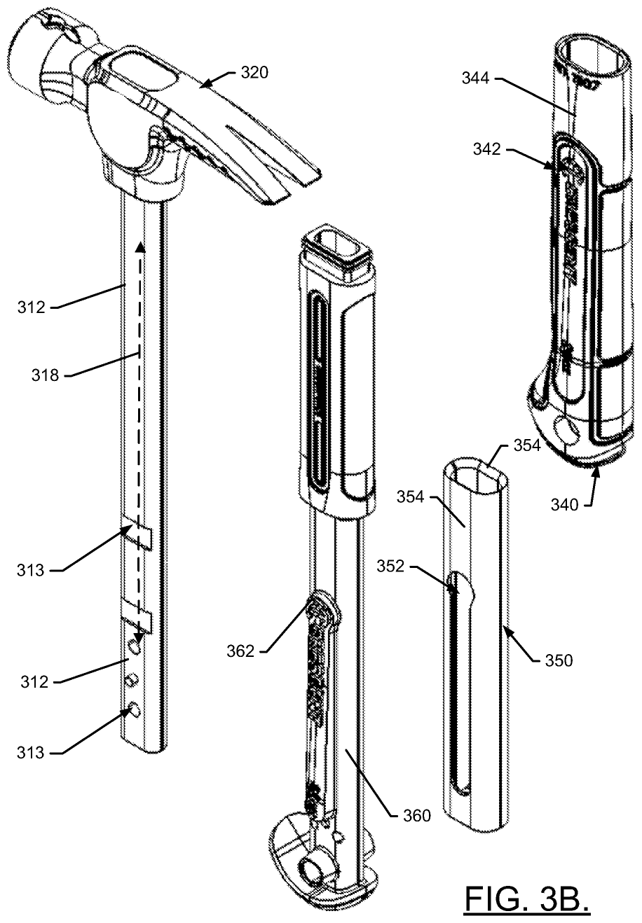

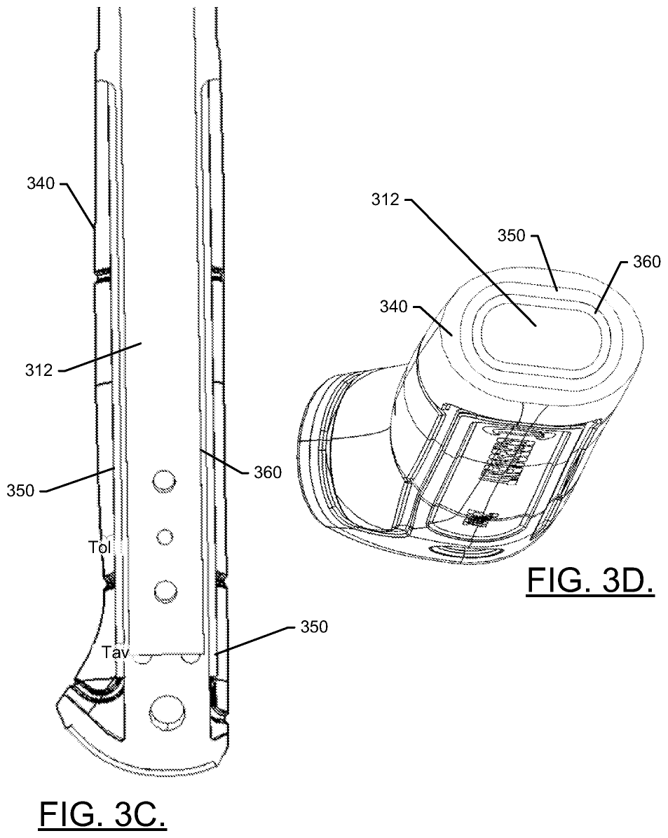

FIG. 3A shows perspective view of a hammer 300 that employs a core 312 that is made of fiber reinforced polymeric material. Meanwhile, FIG. 2B illustrates an exploded view of the various layers used for vibration isolation as discussed above. FIG. 2C shows a cross section view bisecting the grip portion 314 of the hammer 300, and FIG. 2D is a cross section view taken along line B-B′ from FIG. 3A. As shown in FIG. 3A, a head 320 of the hammer 300 is operably coupled to a handle portion 310 that includes a core 312 extending into grip portion 314. The grip portion 314 employs a layered structure as described above in reference to FIG. 1A. In particular, the core 312 may include cavities 313 to enable material from intermediate layer 360 (an example of intermediate layer 160 above) to penetrate therein for mechanical fastening of the core 312 to the intermediate layer 360. The intermediate layer 360 may be molded onto the core 312 as a first step for constructing the hammer 300 (after forging the head 320 and operably coupling the head 320 to the core 312).

Although not required, the intermediate layer 360 may include retention members 362 that extend outwardly from an axis 318 of the handle portion 310. The retention members 362 may be used to mechanically fasten the intermediate layer 360 to an outer layer 340 and/or an anti-vibration layer 350 of the grip portion 314. The retention members 362 in this example include branding materials thereon. However, there is no need for branding to be employed in the retention members 362 and some embodiments may simply employ geometrically shaped protrusions as the retention members 362.

The anti-vibration layer 350 may be molded onto the intermediate layer 360 after the intermediate layer 360 has been molded onto the core 312. However, in some cases, the intermediate layer 360 could be omitted, and the anti-vibration layer 350 may be molded directly onto the core 312. The anti-vibration layer 350 of this example has a substantially rectangular prism shape (albeit with rounded corners between sides), and further has a substantially consistent thickness (Tav). Although not required, the anti-vibration layer 350 also includes retention cavities 352. The retention cavities 352 are molded around the retention members 362, and therefore facilitate mechanical fastening of the anti-vibration layer 350 to the intermediate layer 360, thereby providing inter-layer bonding. Of note, the retention cavities 352 may be formed on lateral sides 354 (i.e., not front or rear sides) of the anti-vibration layer 350. The impact transmitted to the anti-vibration layer 350 when the head 320 strikes an object is typically transmitted in a direction that is parallel to the direction of extension of the lateral sides 354. Thus removing material from the lateral sides 354 of the anti-vibration layer 350 has less impact on damping performance of the anti-vibration layer 350.

The outer layer 340 may then be molded onto the anti-vibration layer 350. The outer layer 340 of this example has a substantially rectangular prism shape (albeit with rounded corners between sides), and further has a thickness (Tol). Of note, a distal end of the outer layer 340 in this example is thicker to enhance gripping for the user. So it should be appreciated that some contouring or other features that enhance grip may be employed to alter the general shape.

Although not required, the outer layer 340 of this example also includes retention orifices 322. The retention orifices are molded around the retention members 362, and therefore facilitate mechanical fastening of the outer layer 340 to the intermediate layer 360, thereby providing inter-layer bonding. Of note, the retention orifices 342 may be formed on lateral sides 364 (i.e., not front or rear sides) of the outer layer 340. As noted above, removing material from the lateral sides 344 of the outer layer 340 may have less impact on damping performance of the outer layer 340.

As best seen in FIGS. 3C and 3D, the outer layer 340 has a greater thickness than the anti-vibration layer 350. Thus, for this example, it can be expected also that the outer layer 340 employs the fourth hardness level range (e.g., Shore A hardness of 48 to 53) and the anti-vibration layer 350 employs the second hardness level range (e.g., Shore A hardness of 10 to 45). However, example embodiments could switch the relative thicknesses by also switching the ranges of hardness levels used (e.g., employing the first and third hardness level ranges noted above). As noted above, alternatives to molding may be used for operably coupling the layers including sleeve (slide-on) construction or clamshell construction.

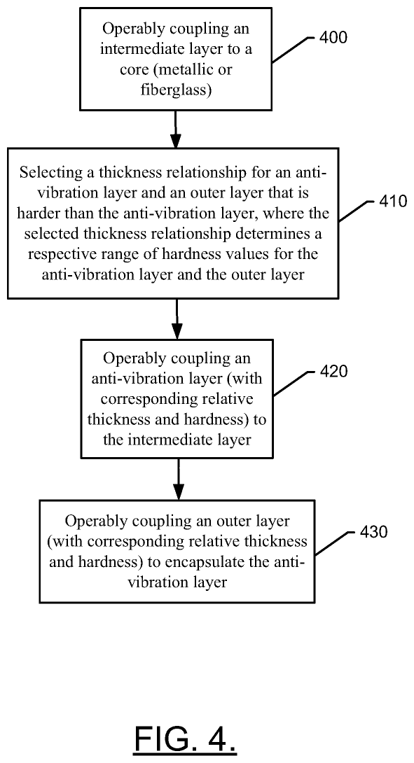

FIG. 4 illustrates a block diagram of a method of manufacturing a hand tool according to example embodiments. The method may include operably coupling an intermediate layer to a core (metallic or fiberglass) at operation 400. The intermediate layer may be molded onto the core, slid over the core, or may be a clamshell design that is fit over the core and joined therewith (e.g., by mechanical fastening or bonding with adhesives). The method may further include selecting a thickness relationship for an anti-vibration layer and an outer layer that is harder than the anti-vibration layer, where the selected thickness relationship determines a respective range of hardness values for the anti-vibration layer and the outer layer (as described above) at operation 410. The method may also include operably coupling the anti-vibration layer (having the selected thickness and hardness) to the intermediate layer at operation 420. The anti-vibration layer may be molded over the intermediate layer, may be slid over the intermediate layer, or may be formed as a two-piece clamshell design that attaches around and encases (at least partially) the intermediate layer. Notably, operation 400 may be optional, and in such cases, operation 420 may be the first step, and the anti-vibration layer may instead by operably coupled to the core instead of to the intermediate layer. Operation 430 may include operably coupling an outer layer (with corresponding relative thickness and hardness) to encapsulate the anti-vibration layer at operation 440. As noted above, the operably coupling may include molding (i.e., over-molding the outer layer onto the anti-vibration layer), sliding the outer layer over the anti-vibration layer, or employing the clamshell design. Some example embodiments may employ a wall section channel for the over-molding process that is optimized to minimize injection pressures. In some embodiments, a gating scheme for over-molding may be parallel to the longest flow length and may also be aligned so that the polymeric material entering the over-mold cavity is in plane with the open cavity space.

As noted above, the anti-vibration layer may always be softer than the outer layer. However, the selection of specific values may depend on design preferences so long as certain design relationships are maintained. In this regard, if the outer layer is to be thicker than the anti-vibration layer, then the outer layer may have a hardness selected between a Shore A hardness of 48 to 53 and the anti-vibration layer may have a hardness selected between a Shore A hardness of 10 to 45. Meanwhile, if the outer layer is to be thinner than the anti-vibration layer, then the outer layer may have a hardness selected between a Shore A hardness of 50 to 65 and the anti-vibration layer may have a hardness selected between a Shore A hardness of 42 to 48. Thus, there is a durometer range ratio between the anti-vibration layer and the outer layer that is a function of the thicknesses of the layers. In this regard, the range ratio for a thicker outer layer involves Shore A hardness ranges from 10 to 45 compared to 48 to 53, resulting in minimum ratios of 0.19 and maximum ratios of 0.94. Meanwhile, the range ratio for a thinner outer layer involves Shore A hardness ranges from 42 to 48 compared to 50 to 65, resulting in minimum ratios of 0.65 and maximum ratios of 0.96.

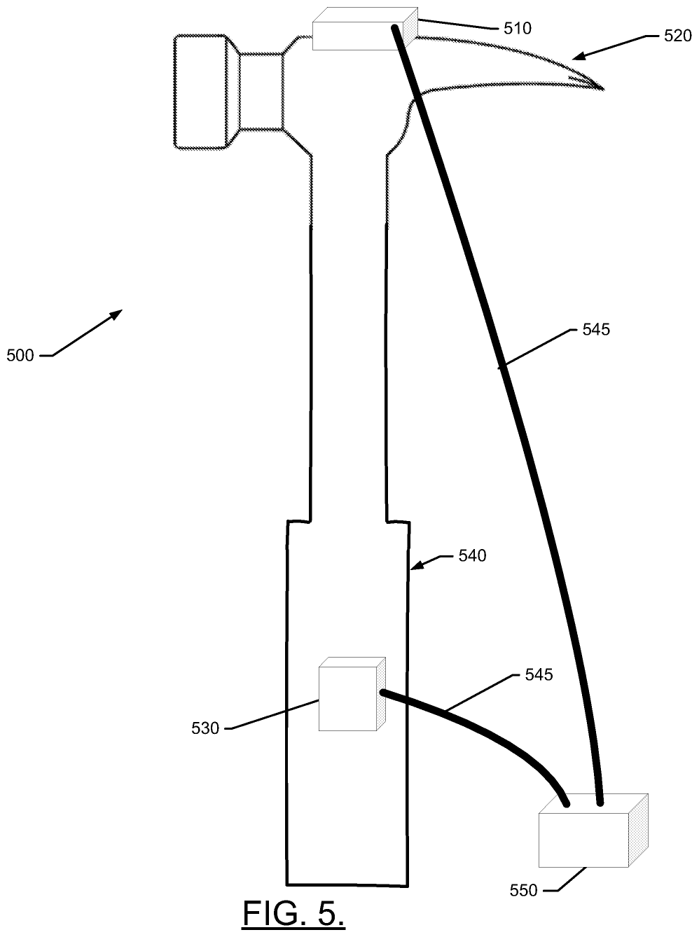

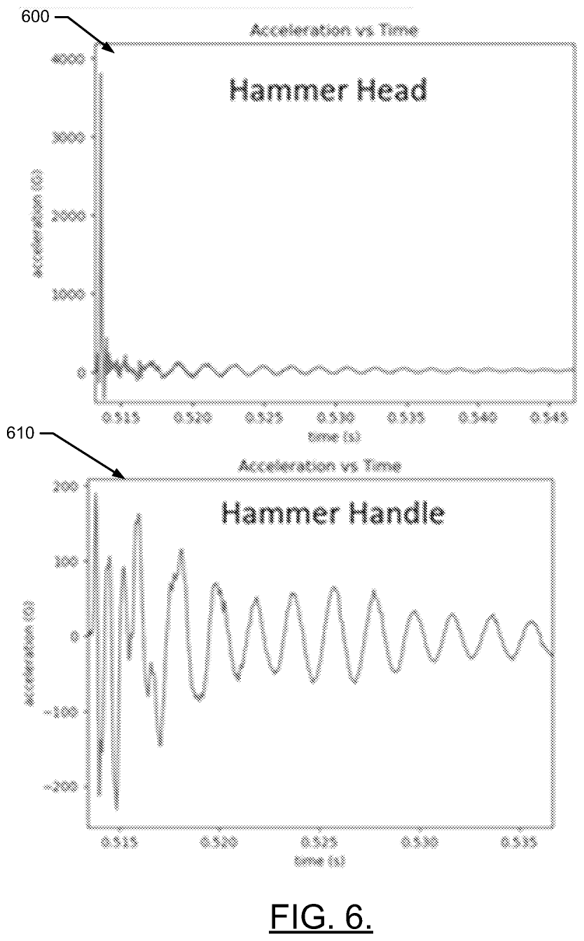

Example embodiments may provide high loss factors with respect to hysteretic damping as the anti-vibration layer may effectively be tuned to act as a shear damper at the macroscopic level, as well as damping at the molecular level due to inherent uniqueness of the anti-vibration layer's molecular structure. Thus, fatigue, discomfort and the amplitude of vibrations experienced by the operator may all be decreased. Testing of example embodiments shows significant reduction in the ratio of maximum handle acceleration to maximum head acceleration. In this regard, FIG. 5 illustrates a hammer 500 (which is constructed according to the descriptions above) having a test rig including a head sensor 510 disposed at a head 520 of the hammer 500, and a handle sensor 530 disposed at the approximate location on the handle 540 at which most user's grip the hammer 500. Cables 545 rigidly (this is important so that the bonding method doesn't contribute to the damping effect) connect the head sensor 510 and the handle sensor 530 to an analyzer 550, and the analyzer 550 is capable of determining plots for acceleration versus time after the hammer 500 performs a strike. FIG. 6 illustrates a plot 600 of acceleration (in Gs) versus time (in seconds) at the head 520, and a plot 610 of acceleration (in Gs) versus time (in seconds) at the handle 540. A ratio of maximum acceleration at the handle 540 to maximum acceleration at the head 520 has been shown to be below 0.075, which is about a 25% reduction relative to other hammers tested with the test rig. Accordingly, a hand tool of an example embodiment may include a head and a handle. The head may have a bell and a face for delivering an impact, and the handle may be operably coupled to the head and extend linearly away from the head along an axis. The handle may include a grip portion proximate to a distal end of the handle. The grip portion may include a core material, an anti-vibration layer disposed around a periphery of the core material in a radial direction substantially perpendicular to the axis, and an outer layer disposed around a periphery of the anti-vibration layer. The anti-vibration layer may be made of a first elastomeric polymeric material and the outer layer may be made of a second elastomeric polymeric material that is harder than the first elastomeric polymeric material. In some embodiments, the first elastomeric polymeric material may have a Shore A hardness between about 10 and about 45 and the second elastomeric polymeric material having a Shore A hardness between about 48 and about 53. In such cases, a thickness of the anti-vibration layer may be thinner than a thickness of the outer layer. However, as an alternative, the first elastomeric polymeric material may have a Shore A hardness between about 42 and about 48 and the second elastomeric polymeric material having a Shore A hardness between about 50 and about 65. In such cases, a thickness of the anti-vibration layer may be thicker than a thickness of the outer layer.

The hand tool (or simply the handle thereof) may include a number of modifications, augmentations, or optional additions, some of which are described herein. The modifications, augmentations or optional additions may be added in any desirable combination. For example, an intermediate layer may be disposed between the core and the anti-vibration layer. In an example embodiment, the intermediate layer may include one or more retention members that extend in the radial direction to provide inter-layer bonding with one or both of the outer layer and the anti-vibration layer. In some cases, the intermediate layer may be molded onto the core, the anti-vibration layer may be molded onto the intermediate layer, and the outer layer may be over-molded onto the anti-vibration layer. In an example embodiment, the core may be metallic material (e.g., forged steel or titanium) having one or more cavities formed therein to enable material from the intermediate layer to penetrate the one or more cavities to mechanically fasten the core to the intermediate layer. In some cases, core may be polymeric material containing fiber reinforcements having one or more cavities formed therein to enable material from the intermediate layer to penetrate the one or more cavities to mechanically fasten the core to the intermediate layer. In an example embodiment, the outer layer may be over-molded onto the anti-vibration layer to encapsulate the anti-vibration layer. In some cases, the thickness of the anti-vibration layer may be up to about 3 mm thinner than the thickness of the outer layer. In an example embodiment, the anti-vibration layer and the outer layer may be mechanically fastened to each other, or bonded to each other via adhesives to provide inter-layer bonding between the outer layer and the anti-vibration layer.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hand tool comprising:
a head having a bell and a face for delivering an impact; and
a handle operably coupled to the head and extending linearly away from the head along an axis,
wherein the handle comprises a grip portion proximate to a distal end of the handle,
wherein the grip portion comprises a core material, an anti-vibration layer disposed around a periphery of the core material in a radial direction substantially perpendicular to the axis, and an outer layer disposed around a periphery of the anti-vibration layer,
wherein the anti-vibration layer is made of a first elastomeric polymeric material having a Shore A hardness between about 42 and about 48,
wherein the outer layer is made of a second elastomeric polymeric material having a Shore A hardness between about 50 and about 65, and
wherein a thickness of the anti-vibration layer is thicker than a thickness of the outer layer.

2. The hand tool of claim 1, wherein an intermediate layer is disposed between the core and the anti-vibration layer.

3. The hand tool of claim 2, wherein the intermediate layer comprises one or more retention members that extend in the radial direction to provide inter-layer bonding with one or both of the outer layer and the anti-vibration layer.

4. The hand tool of claim 2, wherein the intermediate layer is onto the core, the anti-vibration layer is molded onto the intermediate layer, and the outer layer is over-molded onto the anti-vibration layer.

5. The hand tool of claim 2, wherein the core is metallic material having one or more cavities formed therein to enable material from the intermediate layer to penetrate the one or more cavities to mechanically fasten the core to the intermediate layer.

6. The hand tool of claim 2, wherein the core is polymeric material containing fiber reinforcement having one or more cavities formed therein to enable material from the intermediate layer to penetrate the one or more cavities to mechanically fasten the core to the intermediate layer.

7. The hand tool of claim 1, wherein the outer layer is over-molded onto the anti-vibration layer to encapsulate the anti-vibration layer.

8. The hand tool of claim 1, wherein the thickness of the anti-vibration layer is up to about 1 mm thicker than the thickness of the outer layer.

9. The hand tool of claim 1, wherein the anti-vibration layer and the outer layer are mechanically fastened to each other, or bonded to each other via adhesives to provide inter-layer bonding between the outer layer and the anti-vibration layer.

10. A hand tool comprising:
a head having a bell and a face for delivering an impact; and
a handle operably coupled to the head and extending linearly away from the head along an axis,
wherein the handle comprises a grip portion proximate to a distal end of the handle,
wherein the grip portion comprises a core material, an anti-vibration layer disposed around a periphery of the core material in a radial direction substantially perpendicular to the axis, and an outer layer disposed around a periphery of the anti-vibration layer,
wherein the anti-vibration layer is made of a first elastomeric polymeric material having a Shore A hardness between about 10 and about 45,
wherein the outer layer is made of a second elastomeric polymeric material having a Shore A hardness between about 48 and about 53, and
wherein a thickness of the anti-vibration layer is thinner than a thickness of the outer layer.

11. The hand tool of claim 10, wherein an intermediate layer is disposed between the core and the anti-vibration layer.

12. The hand tool of claim 11, wherein the intermediate layer comprises one or more retention members that extend in the radial direction to provide inter-layer bonding with one or both of the outer layer and the anti-vibration layer.

13. The hand tool of claim 11, wherein the intermediate layer is molded onto the core, the anti-vibration layer is molded onto the intermediate layer, and the outer layer is over-molded onto the anti-vibration layer.

14. The hand tool of claim 11, wherein the core is forged steel having one or more cavities formed therein to enable material from the intermediate layer to penetrate the one or more cavities to mechanically fasten the core to the intermediate layer.

15. The hand tool of claim 11, wherein the core is fiber reinforced polymeric material having one or more cavities formed therein to enable material from the intermediate layer to penetrate the one or more cavities to mechanically fasten the core to the intermediate layer.

16. The hand tool of claim 10, wherein the outer layer is over-molded onto the anti-vibration layer to encapsulate the anti-vibration layer.

17. The hand tool of claim 10, wherein the thickness of the anti-vibration layer is up to about 3 mm thinner than the thickness of the outer layer.

18. The hand tool of claim 1, wherein the anti-vibration layer and the outer layer are mechanically fastened to each other, or bonded to each other via adhesives to provide inter-layer bonding between the outer layer and the anti-vibration layer.

19. A hand tool comprising:
a head having a bell and a face for delivering an impact; and
a handle operably coupled to the head and extending linearly away from the head along an axis,
wherein the handle comprises a grip portion proximate to a distal end of the handle,
wherein the grip portion comprises a core material, an anti-vibration layer disposed around a periphery of the core material in a radial direction substantially perpendicular to the axis, and an outer layer disposed around a periphery of the anti-vibration layer,
wherein the anti-vibration layer is made of a first elastomeric polymeric material and the outer layer is made of a second elastomeric polymeric material,
wherein the first elastomeric polymeric material is softer than the second elastomeric polymeric material, and
wherein a maximum acceleration ratio between the head and the handle is 0.075.

20. A method of manufacturing a hand tool, the method comprising:
operably coupling an intermediate layer to a metallic or fiber reinforced polymeric material core;
selecting a thickness relationship for an anti-vibration layer and an outer layer that is harder than the anti-vibration layer, where the selected thickness relationship determines a respective range of hardness values for the anti-vibration layer and the outer layer;
operably coupling the anti-vibration layer having a thickness and hardness determined by the selected thickness relationship and range of hardness values to the intermediate layer; and
operably coupling an outer layer having a thickness and hardness determined by the selected thickness relationship and range of hardness values to encapsulate the anti-vibration layer.
